(19) United States
(12) Patent Application Publication
(10) Pub. No.: US 2010/0123963 A1
(43) Pub. Date: May 20, 2010

(54) MAGNETIC STORAGE APPARATUS, HEAD TEST METHOD, AND HEAD TEST APPARATUS

(75) Inventor: Takeshi Shibasaki, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/570,228

(22) Filed: Sep. 30, 2009

(30) Foreign Application Priority Data
Nov. 17, 2008 (JP) 2008-293221

(51) Int. Cl. G11B 27/36

(52) U.S. Cl. 360/31; G9B/27.052

(57) ABSTRACT

According to one embodiment, a magnetic storage apparatus configured to write data to and read data from a magnetic medium with a head includes a setting module, a write module, a read module, and a quality measurement module. The setting module sets a plurality of sections divided in the track direction of the magnetic medium and a predetermined reference path along the track direction, and also sets at least one offset for each of the sections such that the offset is different between adjacent sections. The offset is the position of the head with respect to the reference path. The write module writes a first data pattern to the offset set by the setting module and writes a second data pattern to the reference path a predetermined number of times. The read module reads the first data pattern written by the write module. The quality measurement module measures the quality of the first data pattern read by the read module.

### CROSS-REFERENCE TO RELATED APPLICATIONS

This application is based upon and claims the benefit of priority from Japanese Patent Application No. 2008-293221, filed on Nov. 17, 2008, the entire contents of which are incorporated herein by reference.

### BACKGROUND

1. Field

One embodiment of the invention relates to a magnetic storage apparatus that tests a head of a magnetic storage apparatus, a head test method, and a head test apparatus.

2. Description of the Related Art

Side erase measurement processing of a conventional magnetic disk apparatus will be described below.

According to an instruction from a magnetic disk apparatus controller, the conventional magnetic disk apparatus performs the side erase measurement processing. The conventional side erase measurement processing is performed, for example, in a manner as described below.

The magnetic disk apparatus controller instructs the magnetic disk apparatus to write a read data pattern in a plurality of predetermined tracks distant from a track adjacent to a center track and read the read data pattern (a signal). The magnetic disk apparatus controller instructs the magnetic disk apparatus to erase-write an erase data pattern in the center track over a plurality of times. The magnetic disk apparatus controller instructs the magnetic disk apparatus to read the read data pattern and measure a side erase characteristic of a magnetic recording head based on deterioration in quality of the signal read upon previous read of the read data pattern.

An arrangement of the read data pattern and the erase data pattern in the conventional side erase measurement processing will be described below.

FIG. 17 illustrates an example of the arrangement of the read data pattern and the erase data pattern in the conventional side erase measurement processing. In the conventional side erase measurement processing, when the read data pattern is written, it is written to all designated tracks.

Track pitch margin (TPIM) measurement processing of the conventional magnetic disk apparatus will be described below.

The TPIM refers to a margin of a track pitch (TP) set in advance. According to an instruction from the magnetic disk apparatus controller, the magnetic disk apparatus performs TPIM measurement processing. The conventional TPIM measurement processing is performed, for example, in a manner as described below.

The magnetic disk apparatus controller instructs the magnetic disk apparatus to write the read data pattern in the center track, read the read data pattern, and measure an error rate of the center track. The magnetic disk apparatus controller instructs the magnetic disk apparatus to write the erase data pattern once with a predetermined offset amount from the center track. The magnetic disk apparatus controller instructs the magnetic disk apparatus to read the read data pattern of the center track and measure an error rate deterioration amount for the error rate previously measured. The magnetic disk apparatus controller instructs the magnetic disk apparatus to repeat the above process while reducing the offset amount with respect to the center track, obtain an offset position which satisfies a condition where an error rate of the read data pattern of the center track is equal or less than a predetermined deterioration amount, and use a difference between the offset position and the TP as the TPIM.

An arrangement of the read data pattern and the erase data pattern in the conventional TPIM measurement processing will be described below.

FIG. 18 illustrates an example of the arrangement of the erase data patterns for the first time in the conventional TPIM measurement processing. FIG. 19 illustrates an example of the arrangement of the erase data patterns for the second time in the conventional TPIM measurement processing. In the conventional TPIM measurement processing, when the erase data patterns are written, they are written to all designated tracks.

FIG. 20 illustrates an example of a measurement result of the conventional TPIM measurement processing. The horizontal axis represents an offset amount, and the vertical axis represents an error rate. When instructing the magnetic disk apparatus to read the read data pattern of the center track and measure an error rate deterioration amount for the error rate previously measured, the magnetic disk apparatus controller plots an error rate of the read data pattern of the center track with respect to the offset amount. When instructing the magnetic disk apparatus to repeat the process while reducing the offset amount with respect to the center track, the magnetic disk apparatus controller obtains an offset amount in which the error rate of the center track is a predetermined error rate threshold value as a measured offset amount. The TPIM is calculated as follows:

TPIM=TP−Measured offset amount

For example, Japanese Patent Application Publication (KOKAI) No. 2005-322275 discloses a conventional offset measurement method of reproducing a magnetic signal having received a magnetic stress when a magnetic signal is recorded on an adjacent track in a magnetic disk apparatus.

However, the conventional side erase measurement processing does not take into account the influence of side erase when a read data pattern is written. For this reason, when read data patterns are written over a plurality of tracks, each of the read data patterns except the one which is lastly written is influenced by the side erase of the next read data pattern which is written after the read data pattern. Therefore, it is difficult to grasp an accurate relationship between the number of times of center erase-write and a signal quality deterioration amount.

As magnetic disk recording density increases, a distance between tracks becomes very narrow (equal to or less than 200 nm), and a perpendicular recording technique has been employed. In a perpendicular recording head, write spreading in the write width direction has a large influence on an adjacent track.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a magnetic disk apparatus test system according to a first embodiment of the invention;

FIG. 2 is an exemplary perspective view of a head and a medium in the first embodiment;

FIG. 3 is an exemplary flowchart of side erase measurement processing in the first embodiment;

FIG. 4 is an exemplary conceptual diagram of an error rate after erase-write in the side erase measurement processing in the first embodiment;

FIG. 5 is an exemplary schematic diagram of a first side erase measurement arrangement in the first embodiment;

FIG. 6 is an exemplary schematic diagram of a second side erase measurement arrangement in the first embodiment;

FIG. 7 is an exemplary flowchart of side erase profile measurement processing in the first embodiment;

FIG. 8 is an exemplary schematic diagram of a profile measurement arrangement in the first embodiment;

FIG. 9 is an exemplary conceptual diagram of an error rate before erase-write in the side erase profile measurement processing in the first embodiment;

FIG. 10 is an exemplary conceptual diagram of the error rate after erase-write in the side erase profile measurement processing in the first embodiment;

FIG. 11 is an exemplary diagram of a TPI_type table in the first embodiment;

FIG. 12 is an exemplary diagram of a BPI_type table in the first embodiment;

FIG. 13 is an exemplary flowchart of TPI/BPI determination processing in the first embodiment;

FIG. 14 is an exemplary flowchart of TP determination processing in the first embodiment;

FIG. 15 is an exemplary conceptual diagram of TP determination processing in the first embodiment;

FIG. 16 is an exemplary block diagram of a head/medium test system according to a second embodiment of the invention;

FIG. 17 is an exemplary schematic diagram of an arrangement of a read data pattern and an erase data pattern in conventional side erase measurement processing;

FIG. 18 is an exemplary schematic diagram of an arrangement of erase data patterns for the first time in conventional TPIM measurement processing;

FIG. 19 is an exemplary schematic diagram of an arrangement of erase data patterns for the second time in the conventional TPIM measurement processing; and

FIG. 20 is an exemplary conceptual diagram of a measurement result of the conventional TPIM measurement processing.

### DETAILED DESCRIPTION

Various embodiments according to the invention will be described hereinafter with reference to the accompanying drawings. In general, according to one embodiment of the invention, a magnetic storage apparatus is configured to write data to and read data from a magnetic medium with a head, and comprises a setting module, a write module, a read module, and a quality measurement module. The setting module is configured to set a plurality of sections divided in the track direction of the magnetic medium and a predetermined reference path along the track direction, and set at least one offset for each of the sections such that the offset is different between adjacent sections. The offset is a position of the head with respect to the reference path. The write module is configured to write a first data pattern to the offset set by the setting module and write a second data pattern to the reference path a predetermined number of times. The read module is configured to read the first data pattern written by the write module. The quality measurement module is configured to measure the quality of the first data pattern read by the read module.

According to another embodiment of the invention, there is provided a head test method of testing a head configured to write data to and read data from a magnetic medium. The head test method comprises: setting a plurality of sections divided in the track direction of the magnetic medium and a predetermined reference path along the track direction, and setting at least one offset for each of the sections such that the offset is different between adjacent sections, the offset being a position of the head with respect to the reference path; writing a first data pattern to the offset set for each of the sections; writing a second data pattern to the reference path a predetermined number of times; reading the written first data pattern; and measuring quality of the first data pattern.

According to still another embodiment of the invention, a head test apparatus tests a head configured to write data to and read data from a magnetic medium, and comprises a setting module, a write module, a read module, and a quality measurement module. The setting module is configured to set a plurality of sections divided in the track direction of the magnetic medium and a predetermined reference path along the track direction, and set at least one offset for each of the sections such that the offset is different between adjacent sections. The offset is a position of the head with respect to the reference path. The write module is configured to write a first data pattern to the offset set by the setting module and write a second data pattern to the reference path a predetermined number of times. The read module is configured to read the first data pattern written by the write module. The quality measurement module is configured to measure the quality of the first data pattern read by the read module.

A configuration of a magnetic disk apparatus test system according to a first embodiment of the invention will be described below.

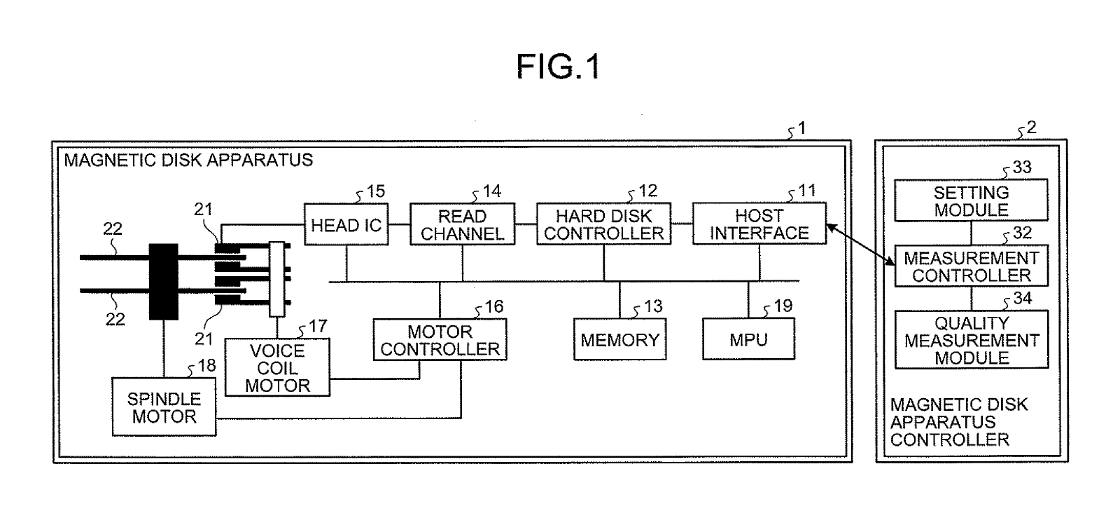

FIG. 1 illustrates an example of a configuration of the magnetic disk apparatus test system according to the first embodiment. The magnetic disk apparatus test system of the first embodiment comprises a magnetic disk apparatus 1 and a magnetic disk apparatus controller 2.

The magnetic disk apparatus 1 comprises a host interface 11, a hard disk controller 12, a memory 13, a read channel 14, a head integrated circuit (IC) 15, a motor controller 16, a voice coil motor 17, a spindle motor 18, a micro processing unit (MPU) 19, the head 21, and the medium 22 (a magnetic medium).

The host interface 11 communicates with a host. In the first embodiment, a host at the time of test is the magnetic disk apparatus controller 2. The MPU 19 instructs the read channel 14 and the motor controller 16 according to a command from the host. The memory 13 stores write data or read data. The hard disk controller 12 performs CRC medium address setting and ECC setting. The read channel 14 demodulates a read signal. The head IC 15 amplifies a write signal to the head 21 and a read signal from the head 21. The motor controller 16 controls the voice coil motor 17 and the spindle motor 18 according to an instruction from the MPU 19.

The medium 22 is a magnetic disk. The head 21 writes data to the medium 22 and reads data from the medium 22. The voice coil motor 17 moves the head 21 under the control of the motor controller 16 in a radial direction of the medium 22. The spindle motor 18 rotates the medium 22 under the control of the motor controller 16.

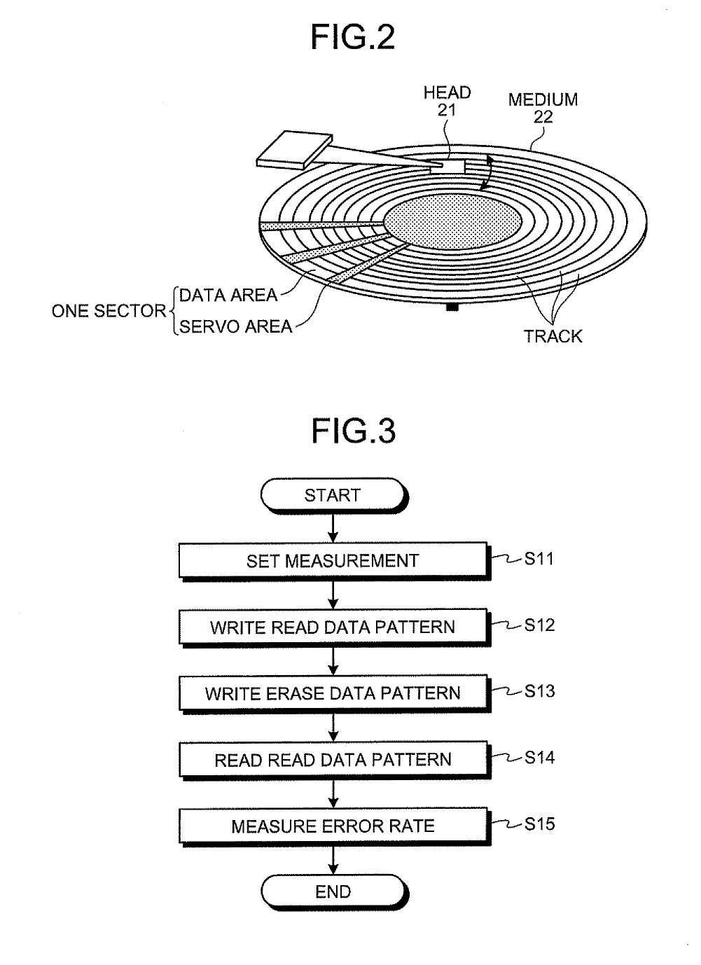

FIG. 2 illustrates an example of a configuration of the head 21 and the medium 22 according to the first embodiment.

The tracks are present on the medium 22 along a circumferential direction (a track direction). A circumferential direction of the medium 22 is divided into a plurality of sectors (sections). One sector has a servo area and a data area. The magnetic disk apparatus 1 has a plurality of the heads 21 and a plurality of the mediums 22.

The magnetic disk apparatus 1 of the first embodiment has functions of a variable track per inch (TPI) and a variable bit per inch (BPI).

The magnetic disk apparatus controller 2 comprises a measurement controller 32, a setting module 33, and a quality measurement module 34. The setting module 33 performs setting of measurement processing. The measurement controller 32 outputs a command for measurement processing to the magnetic disk apparatus 1 and acquires a measurement result from the magnetic disk apparatus 1. The quality measurement module 34 performs an operation related to quality based on the measurement result. A write module and a read module correspond to the measurement controller 32.

The measurement processing described above includes side erase measurement processing, side erase profile measurement processing, TPI/BPI determination processing.

The magnetic disk apparatus controller 2 may be implemented by a computer having a central processing unit (CPU) and a storage device. In this case, the measurement controller 32, the setting module 33, and the quality measurement module 34 are stored in the storage device as software and executed by the CPU.

In the first embodiment, the magnetic disk apparatus controller 2 instructs the magnetic disk apparatus 1 to perform measurement processing, but the MPU 19 of the magnetic disk apparatus 1 may have functions of the measurement controller 32, the setting module 33, and the quality measurement module 34 and instruct measurement processing.

The side erase measurement processing will be described in detail below.

FIG. 3 is a flowchart of an example of the side erase measurement processing according to the first embodiment. First, the setting module 33 sets zones on the head 21 and the medium 22 which are measurement targets, a center track (a reference path), and a side erase measurement arrangement which is an arrangement of read data patterns (first data patterns) (S11).

Next, the measurement controller 32 instructs the magnetic disk apparatus 1 to write the read data patterns to the predetermined tracks distant from a track adjacent to the center track according to the side erase measurement arrangement (S12). The measurement controller 32 instructs the magnetic disk apparatus 1 to erase-write an erase data pattern (a second data pattern) to the center track over a plurality of times (S13).

The measurement controller 32 instructs the magnetic disk apparatus 1 to read the read data patterns (S14). The quality measurement module 34 measures an error rate (quality) deterioration amount of the read signal to measure a side erase characteristic of a magnetic recording head of the head 21 (S15), and the processing ends. The read data patterns may be read before erase-write (S13), and the read result and a read result in which the read data patterns are read (S14) may be compared to measure the side erase characteristic (S15).

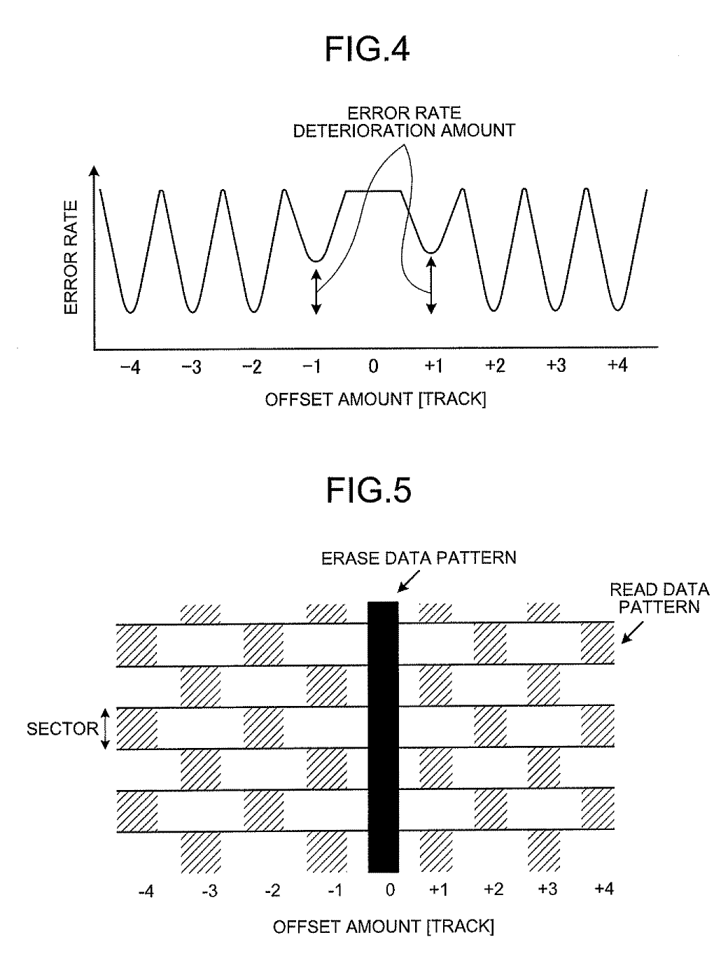

FIG. 4 illustrates an example of an error rate after erase-write in the side erase measurement processing according to the first embodiment. A position of the head 21 in which the center track is used as a reference position is indicated in units of TPs which are determined in advance. The vertical axis represents an error rate. Therefore, an error rate deterioration occurs in tracks around the center track. The deterioration amount is referred to as a side erase characteristic.

A first side erase measurement arrangement and a second side erase measurement arrangement will be described as examples of a side erase measurement arrangement of the read data patterns described above.

The first side erase measurement arrangement will be described below.

FIG. 5 illustrates an example of the first side erase measurement arrangement according to the first embodiment. The horizontal axis represents a position of the head 21 which uses the center track as a reference position and which is indicated in units of TPs which are determined in advance. The vertical axis represents a sector. As illustrated in FIG. 5, in the side erase measurement processing through the first side erase measurement arrangement, the read data patterns are written to areas in which a distance from the center track is within a predetermined distance. The predetermined distance is four tracks and is a distance in which side-erase effect is sufficiently small (is equal to or less than a predetermined level).

In the side erase measurement processing through the first side erase measurement arrangement, tracks in which the read data patterns are written are divided into a group of tracks in which a distance from the center track is an odd-numbered (1 and 3) track and a group of tracks in which a distance from the center track is an even-numbered (2 and 4) track.

Next, in the side erase measurement processing through the first side erase measurement arrangement, for one group of the two groups, the read data patterns are written to the even-numbered tracks, and for the other group, the read data patterns are written to the odd-numbered tracks. According to the first side erase measurement arrangement, the read data patterns which have been written are not influenced by an adjacent side erase (a side erase from an adjacent track) caused by writing of a new read data pattern.

The second side erase measurement arrangement will be described below.

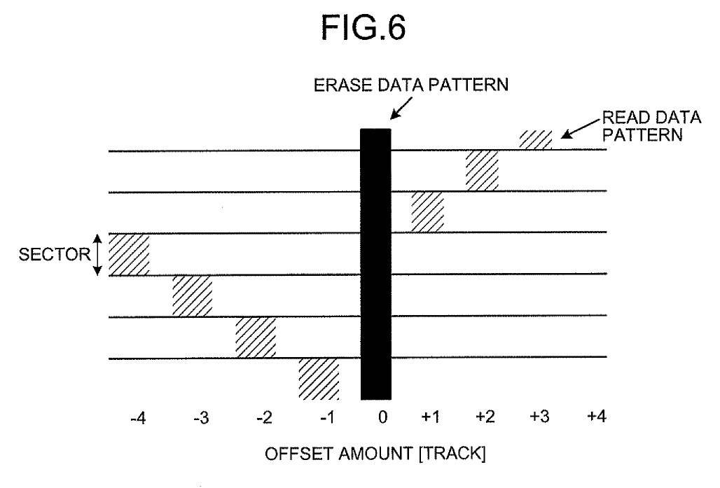

FIG. 6 illustrates an example of the second side erase measurement arrangement according to the first embodiment. The horizontal axis represents a distance from the center track which is indicated in units of TPs which are determined in advance. The vertical axis represents a sector. As illustrated in FIG. 6, in the side erase measurement processing through the second side erase measurement arrangement, similarly to the first side erase measurement arrangement, the read data patterns are written to areas in which a distance from the center track is within four tracks. In the side erase measurement processing through the second side erase measurement arrangement, a track and a sector in which the read data pattern is written are designated according to a predetermined order so that only one track is to be involved in writing the read data pattern in one sector.

According to the second side erase measurement arrangement, a sector in which the data read pattern is written is designated for each track, and thus the read data patterns which have been written are not influenced by a side erase caused by writing for a track distant from the adjacent track. Further, the use of the second side erase measurement arrangement reduces the number of sectors from which the read data patterns are read after erase-write as compared to conventional side erase measurement processing.

However, since the sectors (equal to or less than 1,000 sectors) are present in one round of a track, when writing or reading of the sectors for one track are performed and characteristics are averaged (statistically processed), the conventional side erase measurement processing and the side erase measurement processing using the first side erase measurement arrangement can have the same accuracy. For example, the setting module 33 repetitively arranges the second side erase measurement arrangement in other sectors twice or more times and calculates an average of error rates obtained from the read data patterns of the different sectors in which the same offset amount is set.

With the side erase measurement processing according to the first embodiment, the read data pattern is written to a different sector for each track. Therefore, there is no influence by the side erase of writing of the read data pattern, and it is possible to grasp an exact relationship between the number of center erase-write times and the signal quality deterioration amount.

The side erase profile measurement processing will be described in detail below.

In the conventional side erase measurement processing, when the read data pattern is written, each read data pattern is written according to a track pitch which is determined in advance. For this reason, a considerable time is required to measure an erase profile between hundreds of nanometers (nm) from the center track to the adjacent track.

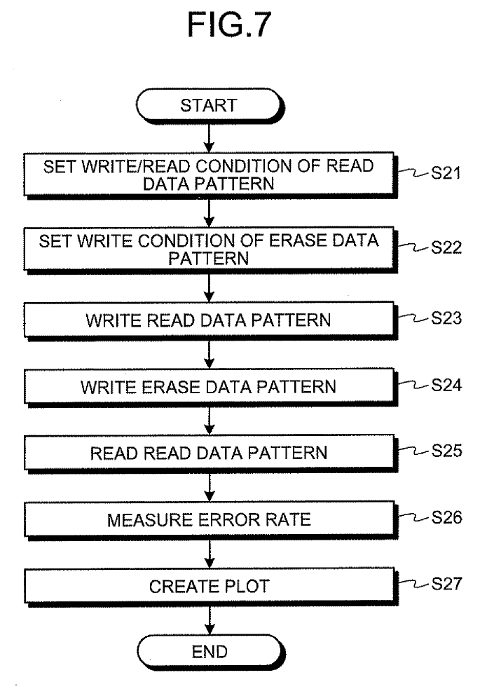

FIG. 7 is a flowchart of an example of the side erase profile measurement processing according to the first embodiment. First, the setting module 33 sets an offset amount of a predetermined profile measurement arrangement and a use sector as a write/read condition of the read data pattern (S21).

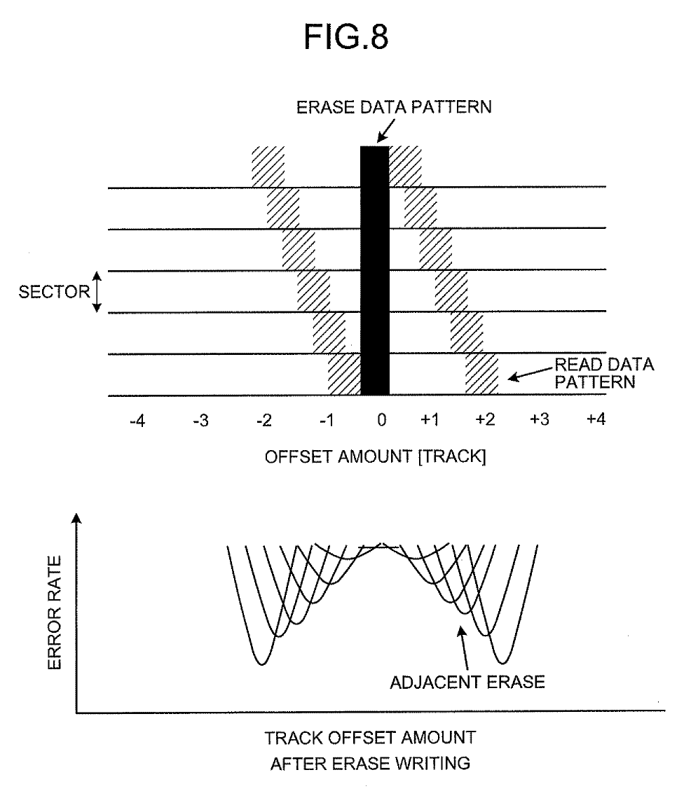

FIG. 8 illustrates an example of a profile measurement arrangement according to the first embodiment. The horizontal axis represents a track position which uses an initial TP0 value of the TP as a unit. A track position of the center track is zero (0). The vertical axis represents a sector.

For the read data pattern, a different amount of offset is assigned to each sector. When a predetermined unit offset amount which is smaller than TP0 is OS0, an offset amount of the read data pattern is set to vary by OS0 between adjacent sectors. When a plurality of read data patterns are written to one sector, an interval between the read data patterns is set to be equal to or larger than an interval at which influence of the side erase can be ignored.

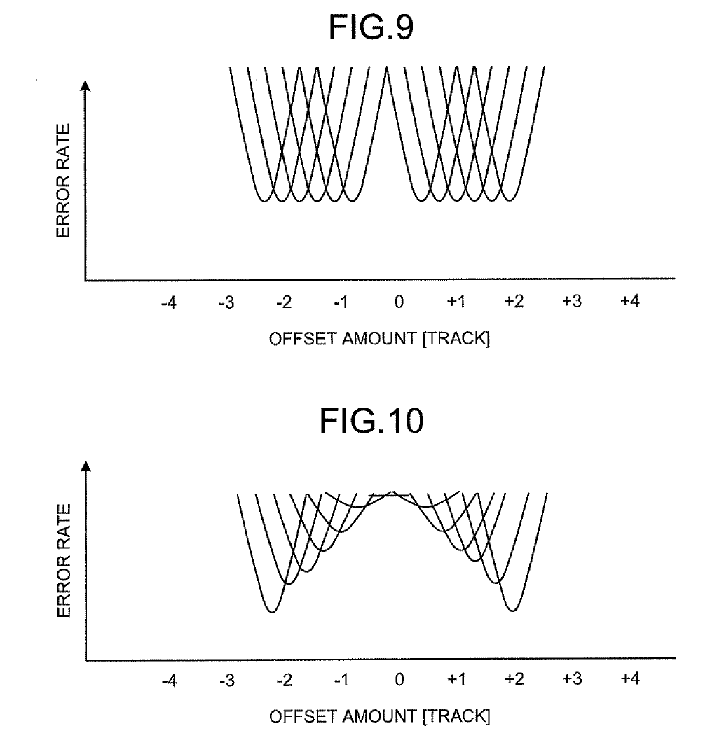

FIG. 9 illustrates an example of an error rate before erase-write in the side erase profile measurement processing according to the first embodiment. Since a profile measurement arrangement is used, there is no influence of the side erase, and thus the error rates of the respective read data patterns are constant.

Next, the setting module 33 sets the number of write times as a write condition of the erase data pattern (S22).

The measurement controller 32 writes the read data pattern to the center track (S23). The measurement controller 32 then writes the erase data pattern according to the profile measurement arrangement and the number of write times (S24). The measurement controller 32 reads the read data pattern (S25). The quality measurement module 34 measures an error rate of the read data (S26). The quality measurement module 34 then interpolates the measurement result to create a plot of an error rate to an offset amount (S27), and the processing ends. The read data pattern may be read before writing the erase data pattern (S24), and the read result and a read result when the read data pattern is read (S25) may be compared to create the plot of the error rate to the offset amount (S27).

FIG. 10 illustrates an example of the error rate after erase-write in the side erase profile measurement processing according to the first embodiment. The error rate of the read data pattern further deteriorates as it is closer to the center track.

In the side erase profile measurement processing according to the first embodiment, when the read data patterns are written at a pitch smaller than a track pitch over the sectors, a detailed side erase profile can be measured. When this method is used, a generation position of a leakage magnetic field can be specified in detail at the time of fault analysis.

In the side erase profile measurement processing, since the read data pattern is written to a different sector for each track, the read data pattern can be written at an interval which is not bound by the TPIM. Therefore, a detail side erase profile can be measured.

The TPI/BPI determination processing will be described in detail below.

The setting module 33 stores a TPI_type table in which a plurality of TPIs (TPI_types) are set in advance and a BPI_type table in which a plurality of BPIs (BPI_types) are set in advance.

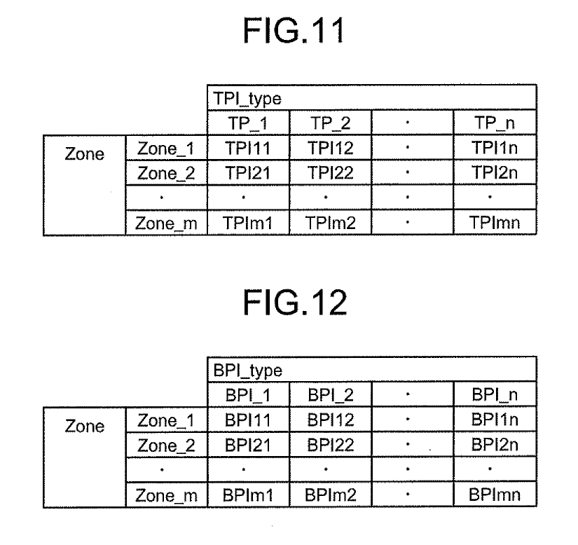

FIG. 11 illustrates an example of a TPI_type table according to the first embodiment. The TPI_type Table stores TPIs of n types which are set in advance as TPI_types for each of m zones on the medium 22. m rows correspond to zone nos. 1 to m, respectively, and n columns correspond to TPI_type nos. 1 to n, respectively. The larger the TPI_type number is, the higher the TPI is.

FIG. 12 illustrates an example of a BPI_type table according to the first embodiment. The BPI_type Table stores BPIs of n types which are set in advance as BPI_types for each of m zones on the medium 22. m rows correspond to zone nos. 1 to m, respectively, and n columns correspond to BPI_type nos. 1 to n, respectively. The larger the BPI_type number is, the higher the BPI is.

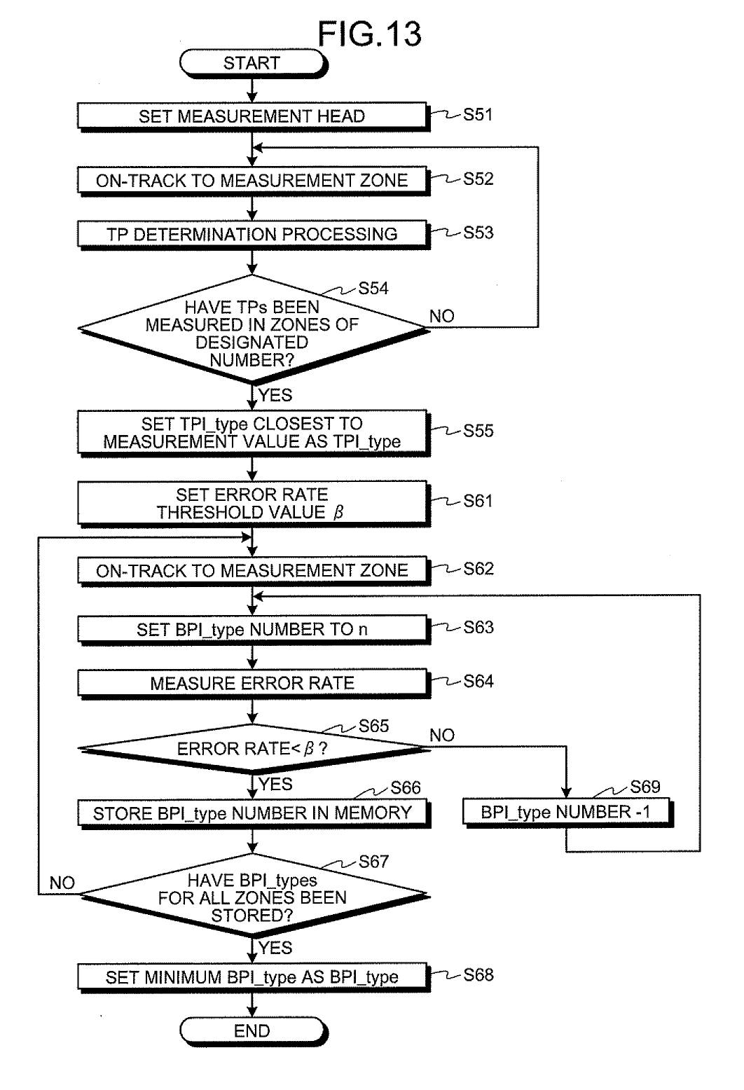

FIG. 13 is a flowchart of an example of the TPI/BPI determination processing according to the first embodiment. The process from S51 to S55 is of selecting and setting an optimum TPI from the TPI_type table. The process from S61 to S69 is of selecting and setting an optimum BPI from the BPI_type table.

First, the setting module 33 selects and sets a measurement head which is a measurement target from among the heads 21 (S51). Next, the measurement controller 32 selects a measurement zone which is a measurement target zone from among the m predetermined zones and on-tracks the measurement head to the measurement zone (S52). Next, the measurement controller 32 performs TP determination processing of determining the TP (S53). Next, the measurement controller 32 determines whether the TP determination processing for all the predetermined zones is finished (S54).

When the TP determination processing for all the predetermine zones has not been finished (No at S54), the flow returns to S52, and the measurement controller 32 selects a next measurement zone.

When the TP determination processing for all the predetermine zones has been finished (Yes at S54), the setting module 33 selects TPI_type closest to the TP determined by the TP determination processing from TPI_types of the TPI_type table corresponding to the measurement zone and sets the selected TPI_type as TPI_type of the magnetic disk apparatus 1 (S55).

Next, the setting module 33 sets an error rate threshold value β (S61). Next, the measurement controller 32 selects a measurement zone from among the m zones and on-tracks the measurement head to the measurement zone (S62). Next, the setting module 33 sets a BPI_type number of the BPI_type table (S63).

Here, an initial value of the BPI_type number is n. Next, the quality measurement module 34 measures an error rate (S64). Next, the quality measurement module 34 determines whether or not the measured error rate is smaller than β (S65).

When the measured error rate is not smaller than β (No at S65), the setting module 33 sets the BPI_type number to −1 (S69), and the flow returns to S64. When the measured error rate is smaller than β (Yes at S65), the quality measurement module 34 stores the BPI_type in a memory (S66). Next, the setting module 33 determines whether or not all BPI_types of the m zones have been stored in the memory (S67).

When all BPI_types of the m zones have not been stored in the memory (No at S67), the flow returns to S62, and the setting module 33 selects a next measurement zone.

When all BPI_types of the m zones have been stored in the memory (Yes at S67), the setting module 33 compares the BPI_types of the respective zones, sets the minimum BPI_type as the BPI_type of the magnetic disk apparatus 1 (S68), and the processing ends.

The TP determination processing will be described in detail below.

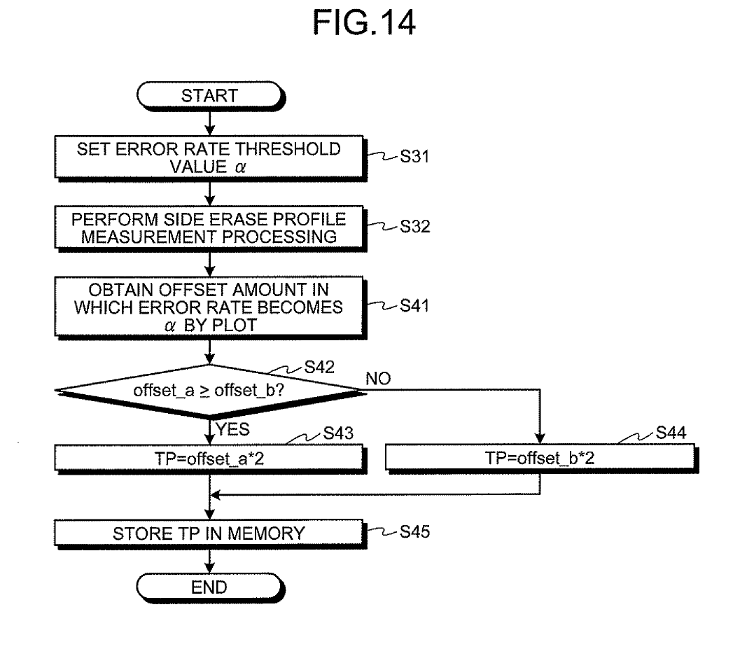

FIG. 14 is a flowchart of an example of the TP determination processing according to the first embodiment. First, the setting module 33 sets an error rate threshold value α (S31). Next, the measurement controller 32 and the quality measurement module 34 perform the side erase profile measurement processing as described above (S32).

Next, the quality measurement module 34 obtains a limit offset amount which is an offset amount in which an error rate becomes the predetermined threshold value α by the plot created by the side erase profile measurement processing (S41). The limit offset amount includes two offset amounts of offset_a which is an absolute value of an offset amount in which an error rate is α at a plus offset side of the center track and offset_b which is an absolute value of an offset amount in which an error rate is α at a minus offset side of the center track. The quality measurement module 34 interpolates the plot of the error rate to the offset amount to obtain an approximate straight line. offset_a and offset_b are obtained by the approximate straight line.

Next, the quality measurement module 34 determines whether or not offset_a is equal to or greater than offset_b (S42). When offset_a is equal to or greater than offset_b (Yes at S42), the quality measurement module 34 determines the TP through offset_a*2 (S43). When offset_a is not equal to or greater than offset_b (No at S42), the quality measurement module 34 determines the TP through offset_b*2 (S44). Next, the quality measurement module 34 stores the determined TP in the memory (S45), and the processing ends.

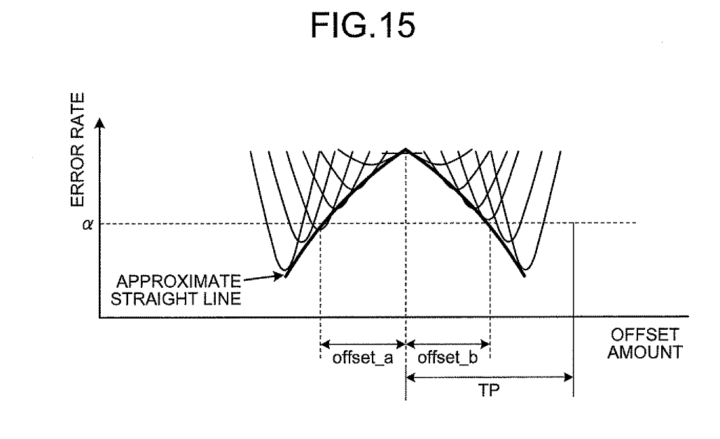

FIG. 15 illustrates an example of the TP determination processing according to the first embodiment. The horizontal axis represents an offset amount, and the vertical axis represents an error rate. The approximate straight line is obtained such that error rates obtained for respective offset amounts are interpolated by a straight line. An absolute value of a negative offset amount in which a value of the approximate straight line is α is offset_a, and an absolute value of a positive offset amount in which a value of the approximate straight line is α is offset_b. In this example, offset_a is smaller than offset_b, and the TP is set to offset_b*2.

In conventional TPIM measurement processing, when writing is performed in the same track a plurality of times, an error rate deterioration amount cannot be guaranteed. In conventional TPIM measurement processing, if writing is performed a plurality of times, since writing is performed at respective offset positions a plurality of times, a measurement time drastically increases.

According to the TP determination processing of the first embodiment, a track pitch in which an adjacent side erase deterioration amount by a plurality of times of writing is guaranteed can be determined in less measurement time.

Accordingly, the quality of the magnetic disk apparatus 1 can be improved.

A configuration of a head/medium test system according to a second embodiment of the invention will be described below.

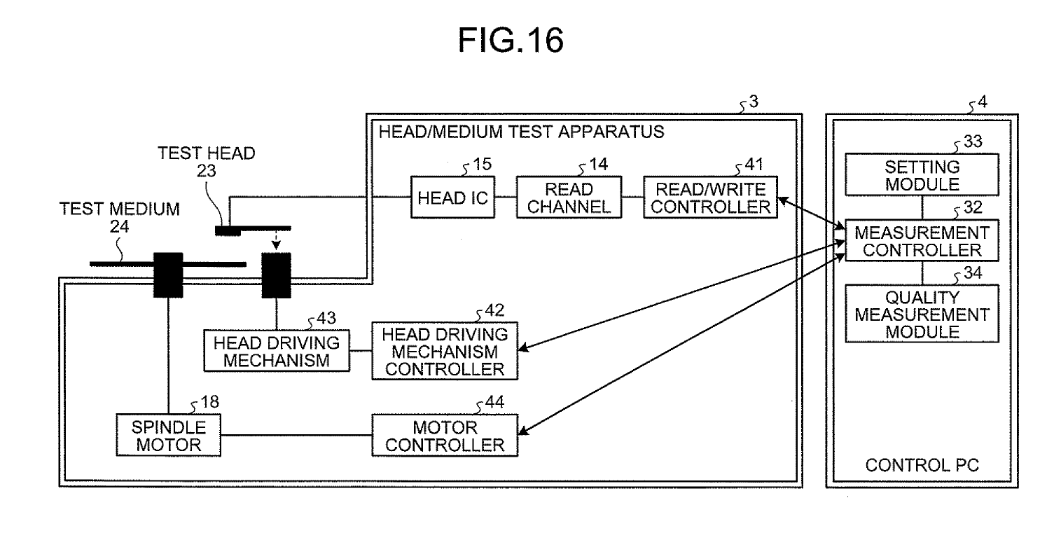

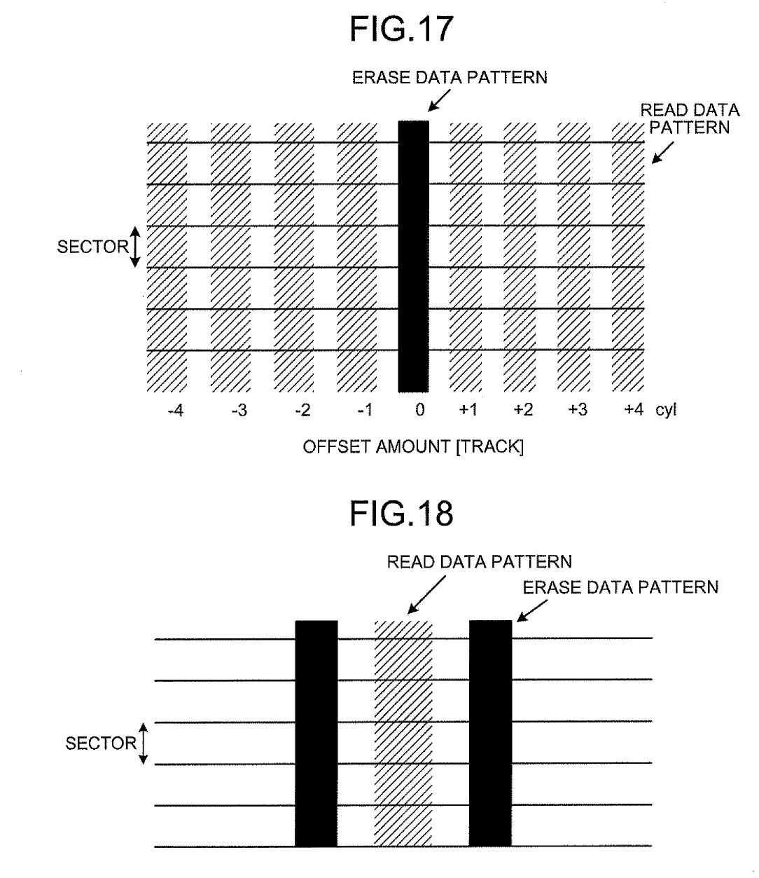

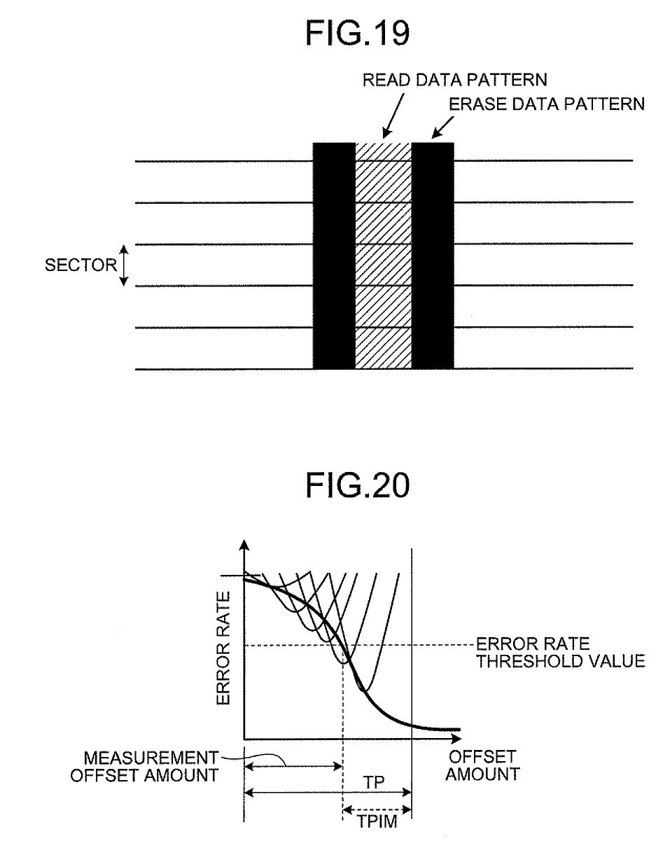

FIG. 16 illustrates an example of a configuration of the head/medium test system according to the second embodiment. Constituent elements corresponding to those previously described in connection with FIG. 1 will be designated by the same reference numerals, and their description will not be repeated. The head/medium test system of the second embodiment comprises a head/medium test apparatus 3, a control personal computer (PC) 4, a test head 23, and a test medium 24. The test head 23 and the test medium 24 are fixed to the head/medium test apparatus 3.

The head/medium test apparatus 3 comprises the read channel 14, the head IC 15, the spindle motor 18, a read/write controller 41, a head driving mechanism controller 42, a head driving mechanism 43, and a motor controller 44.

The read/write controller 41 transmits a data pattern from the control PC 4 to the read channel 14 and transmits a data pattern from the read channel 14 to the control PC 4. The head driving mechanism controller 42 applies an electric current to the head driving mechanism 43 according to an instruction from the control PC 4. The head driving mechanism 43 drives the test head 23. The motor controller 44 applies an electric current to the spindle motor 18 according to an instruction from the control PC 4.

The control PC 4 comprises the measurement controller 32, the setting module 33, and the quality measurement module 34. The control PC 4 is provided with a CPU and a storage device. In this case, the measurement controller 32, the setting module 33, and the quality measurement module 34 are stored in the storage device as software and executed by the CPU.

The head/medium test system of the second embodiment performs measurement processing similar to that performed by the magnetic disk apparatus test system of the first embodiment.

While, in the second embodiment, the control PC 4 is described as instructing the head/medium test apparatus 3 to perform measurement processing, the head/medium test apparatus 3 may have functions of the measurement controller 32, the setting module 33, and the quality measurement module 34 and issue an instruction for measurement processing.

As set forth hereinabove, according to an embodiment of the invention, it is possible to reduce influence of side erase due to writing of a read data pattern in measurement related to the side erase.

While the embodiments are described above as being applied to a magnetic disk apparatus in which a magnetic disk is used as a medium, the embodiments may be applied to a magnetic storage apparatus having a magnetic medium such as a magnetic drum.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic storage apparatus configured to write data to and read data from a magnetic medium with a head, the magnetic storage apparatus comprising:
a setting module configured to set a plurality of sections divided in a track direction of the magnetic medium and a predetermined reference path along the track direction, and set at least one offset for each of the sections such that the offset is different between adjacent sections, the offset being a position of the head with respect to the reference path;
a write module configured to write a first data pattern to the offset set by the setting module and write a second data pattern to the reference path a predetermined number of times;
a read module configured to read the first data pattern written by the write module; and
a quality measurement module configured to measure quality of the first data pattern read by the read module.

2. The magnetic storage apparatus of claim 1, wherein the setting module is configured to set the offset to a multiple of a predetermined track pitch.

3. The magnetic storage apparatus of claim 2, wherein, when setting a plurality of offsets for a section, the setting module sets the offsets at an interval twice or more the track pitch.

4. The magnetic storage apparatus of claim 3, wherein the setting module is configured to set an offset of either an odd-numbered section or an even-numbered section to an odd-numbered multiple of the track pitch and an offset of either the even-numbered section or the odd-numbered section to an even-numbered multiple of the track pitch, respectively.

5. The magnetic storage apparatus of claim 1, wherein the setting module is configured to set one offset for one section.

6. The magnetic storage apparatus of claim 1, wherein the setting module is configured to set the offset to a value smaller than an initial value of a predetermined track pitch.

7. The magnetic storage apparatus of claim 6, wherein the predetermined number of times is a plurality of times.

8. The magnetic storage apparatus of claim 6, wherein the quality measurement module is configured to calculate a relationship between the offset and the quality of the first data pattern read from the offset.

9. The magnetic storage apparatus of claim 8, wherein the quality measurement module is configured to calculate a limit offset in which the quality is at a predetermined limit value based on the relationship between the offset and the quality.

10. The magnetic storage apparatus of claim 9, wherein the quality measurement module is configured to determine a track pitch for subsequent write or read based on the limit offset.

11. The magnetic storage apparatus of claim 10, wherein the quality measurement module is configured to determine the track pitch for each zone of the magnetic medium.

12. The magnetic storage apparatus of claim 11, wherein the quality measurement module is configured to optimizes recording density in the track direction for each zone.

13. The magnetic storage apparatus of claim 1, wherein the setting module is configured to set the offset within a predetermined distance.

14. The magnetic storage apparatus of claim 13, wherein the predetermined distance is a distance in which side-erase effect is equal to or less than a predetermined level.

15. The magnetic storage apparatus of claim 1, wherein
the setting module is configured to repetitively set the sections, and
the quality measurement module is configured to obtain statistics of measurement results of the quality of the first data pattern read from identical offsets in the different sections.

16. The magnetic storage apparatus of claim 1, wherein the quality is an error rate.

17. The magnetic storage apparatus of claim 1, wherein the sections are sectors.

18. A head test method of testing a head configured to write data to and read data from a magnetic medium, the head test method comprising:
setting a plurality of sections divided in a track direction of the magnetic medium and a predetermined reference path along the track direction, and setting at least one offset for each of the sections such that the offset is different between adjacent sections, the offset being a position of the head with respect to the reference path;
writing a first data pattern to the offset set for each of the sections;
writing a second data pattern to the reference path a predetermined number of times;
reading the written first data pattern; and
measuring quality of the first data pattern.

19. Ahead test apparatus that tests a head configured to write data to and read data from a magnetic medium, the head test apparatus comprising:
a setting module configured to set a plurality of sections divided in a track direction of the magnetic medium and a predetermined reference path along the track direction, and set at least one offset for each of the sections such that the offset is different between adjacent sections, the offset being a position of the head with respect to the reference path;
a write module configured to write a first data pattern to the offset set by the setting module and write a second data pattern to the reference path a predetermined number of times;
a read module configured to read the first data pattern written by the write module; and
a quality measurement module configured to measure quality of the first data pattern read by the read module.
